(19) United States
(12) Patent Application Publication
(10) Pub. No.: US 2026/0342448 A1
(43) Pub. Date: Oct. 29, 2026

(54) METHOD AND SYSTEM FOR COHERENT OPTICAL SIGNAL RECEPTION

(71) Applicant: HUAWEI TECHNOLOGIES CO., LTD., Shenzhen (CN)

(72) Inventors: Hossein Najafi, Stittsville (CA); Ali Bakhshali, Stittsville (CA); Zhuhong Zhang, Ottawa (CA); Zhiping Jiang, Kanata (CA); Yule Xiong, Stittsville (CA)

(21) Appl. No.: 19/307,469

(22) Filed: Aug. 22, 2025

Related U.S. Application Data
(60) Provisional application No. 63/793,947, filed on Apr. 24, 2025.

(51) Int. Cl. H04B 10/61

(52) U.S. Cl. CPC H04B 10/614; H04B 10/6162

(57) ABSTRACT

A coherent optical receiver and corresponding method recovers modulation symbols from a dual-polarization optical signal without requiring alignment between the polarization state of a local oscillator (LO) and that of the received signal. The receiver includes one or more optical hybrids configured to mix the LO and dual-polarization signal, a set of photodetectors arranged in a space-polarization-coded configuration to convert mixed optical signals into electrical signals, and a digital signal processor (DSP) to recover the modulation symbols. The architecture reduces hardware complexity compared to other redundant receiver structures while enabling a flat polarization-insensitive operation suitable for short-reach and cost-sensitive optical communication systems.

### CROSS REFERENCE

The present application claims priority to U.S. Provisional Pat. Appl. Ser. No. 63/793,947 filed Apr. 24, 2025, entitled “METHOD AND SYSTEM FOR COHERENT OPTICAL SIGNAL RECEPTION,” the contents of which are incorporated wholly by reference herein.

### TECHNICAL FIELD

The present disclosure relates to systems and methods for coherent optical signal reception, and in particular to local oscillator polarization-insensitive (LO-PI) integrated coherent receivers for use in optical communication systems.

### BACKGROUND

In coherent optical communication systems, dual-polarization transmission is widely used for efficient spectral utilization. At the receiver, a local oscillator (LO) laser enables coherent detection of amplitude and phase information. The polarization state of the LO relative to the received signal affects the detection process, and existing receiver architectures typically incorporate measures for handling polarization.

Known approaches include active polarization controllers (APCs) that dynamically align the LO polarization state, and polarization-maintaining fibers or cores that preserve a stable LO polarization during transmission. These approaches may add complexity, cost, or have limited tracking performance. Other proposed designs employ additional receiver components such as extra photodiodes, hybrids, or waveguide structures to increase polarization diversity, sometimes requiring more than four analog-to-digital converters (ADCs) for dual-polarization coherent detection.

Alternative receiver concepts have been explored for self-coherent architectures, where the LO is transmitted along with the data signal, either in the same fiber or over a separate path. Such schemes can be relevant for short-reach applications, including data-center interconnects, but still often require polarization handling or component redundancy to maintain detection performance. Some reported designs rely on complex optical configurations or emerging technologies such as metasurfaces, which may present manufacturing or scalability challenges.

Across these implementations, the need to manage LO polarization, whether through active control, specialized fiber, or complex receiver designs, remains a consideration in practical coherent optical systems.

### SUMMARY

According to a first aspect, there is provided an apparatus for coherent detection of a dual-polarization optical signal, comprising: a plurality of optical hybrids configured to receive the dual-polarization optical signal and a local oscillator signal, and to optically mix polarization components thereof to generate a plurality of mixed optical outputs, each representing a combination of polarization components of the dual-polarization optical signal and the local oscillator signal; a plurality of photodetectors; and a set of optical routing connections arranged according to a predetermined connection pattern to route the mixed optical outputs to the plurality of photodetectors such that each of the plurality of photodetectors receives a distinct combination of polarization components of the dual-polarization optical signal and the local oscillator signal, wherein the routing of the mixed optical outputs defines a linear transformation between the dual-polarization optical signal and electrical signals generated by the photodetectors, the linear transformation being unitary.

In some embodiments, the plurality of optical hybrids may comprise at least two 90-degree optical hybrids.

In some embodiments, the plurality of optical hybrids may comprise four 90-degree optical hybrids, each receiving a respective polarization component of the dual-polarization optical signal and a respective polarization component of the local oscillator signal.

In some embodiments, each of the four 90-degree optical hybrids may produce four of the mixed optical outputs, and the plurality of photodetectors may comprise between four and eight photodetectors, the plurality of photodetectors including at least one of: (i) four single-ended photodetectors, each connected via a respective one-to-one connection to two of the mixed optical outputs; (ii) eight photodetectors, each receiving a respective one of the mixed optical outputs; or (iii) a mixed configuration including single-ended photodetectors and balanced photodetector pairs to provide incremental performance between the four-photodetector and eight-photodetector configurations.

In some embodiments, the apparatus may further comprise: two polarization beam splitters, each configured to separate polarization components of the dual-polarization optical signal and the local oscillator signal, respectively; four beam splitters configured to distribute the separated polarization components to the four 90-degree optical hybrids; and eight polarization beam combiners positioned between the set of optical routing connections and the eight photodetectors, each of the polarization beam combiners configured to combine two of the mixed optical outputs prior to photodetection.

In some embodiments, the set of optical routing connections may comprise one-to-one optical waveguide connections between outputs of the four 90-degree optical hybrids and inputs of the eight polarization beam combiners.

In some embodiments, the plurality of photodetectors may comprise four balanced photodetector pairs, each configured to subtract photocurrents to generate a differential electrical signal for coherent detection.

In some embodiments, the differential electrical signal may be generated from photocurrents corresponding to a respective combination of polarization components of the dual-polarization optical signal and the local oscillator signal.

In some embodiments, the apparatus may further comprise: a plurality of analog-to-digital converters configured to digitize the electrical signals; and a digital signal processor configured to process the digitized electrical signals to recover modulation symbols carried by the dual-polarization optical signal.

In some embodiments, the digital signal processor may be further configured to jointly equalize the linear transformation defined by the routing and an optical fiber channel response.

According to a second aspect, there is provided a method for coherent detection of a dual-polarization optical signal, the method comprising: receiving the dual-polarization optical signal and a local oscillator signal at a plurality of optical hybrids; optically mixing, at the plurality of optical hybrids, the dual-polarization optical signal and the local oscillator signal to generate a plurality of mixed optical outputs, each representing a combination of polarization components of the dual-polarization optical signal and the local oscillator signal; routing the plurality of mixed optical outputs to a plurality of photodetectors through a set of optical routing connections arranged according to a predetermined connection pattern such that each of the plurality of photodetectors receives a distinct combination of polarization components of the dual-polarization optical signal and the local oscillator signal; and generating electrical signals at the plurality of photodetectors based on the received mixed optical outputs, wherein the routing of the mixed optical outputs defines a linear transformation between the dual-polarization optical signal and the electrical signals, the linear transformation being unitary.

In some embodiments, the plurality of optical hybrids may comprise at least two 90-degree optical hybrids.

In some embodiments, the plurality of optical hybrids may comprise four 90-degree optical hybrids, each receiving a respective polarization component of the dual-polarization optical signal and a respective polarization component of the local oscillator signal.

In some embodiments, each of the four 90-degree optical hybrids may produce four of the mixed optical outputs, and the plurality of photodetectors may comprise between four and eight photodetectors, the plurality of photodetectors including at least one of: (i) four single-ended photodetectors, each connected via a respective one-to-one connection to two of the mixed optical outputs; (ii) eight photodetectors, each receiving a respective one of the mixed optical outputs; or (iii) a mixed configuration including single-ended photodetectors and balanced photodetector pairs to provide incremental performance between the four-photodetector and eight-photodetector configurations.

In some embodiments, the dual-polarization optical signal and the local oscillator signal may be each passed through two polarization beam splitters to separate the respective polarization components, four beam splitters may be used to distribute the separated polarization components to the four 90-degree optical hybrids, and eight polarization beam combiners may be positioned between the set of optical routing connections and the eight photodetectors, such that each of the polarization beam combiners combines two of the mixed optical outputs prior to photodetection.

In some embodiments, the set of optical routing connections may comprise one-to-one optical waveguide connections between outputs of the four 90-degree optical hybrids and inputs of the eight polarization beam combiners.

In some embodiments, the plurality of photodetectors may comprise four balanced photodetector pairs, each configured to subtract photocurrents to generate a differential electrical signal for coherent detection.

In some embodiments, the method may further comprise performing coherent current differentiation to generate the differential electrical signal from photocurrents corresponding to a respective combination of polarization components of the dual-polarization optical signal and the local oscillator signal.

In some embodiments, the method may further comprise: digitizing the electrical signals using a plurality of analog-to-digital converters; and processing the digitized electrical signals using a digital signal processor to recover modulation symbols carried by the dual-polarization optical signal.

In some embodiments, the processing may comprise jointly equalizing the linear transformation defined by the routing of the mixed optical outputs and an optical fiber channel response.

According to a third aspect, there is provided an apparatus for coherent detection of a dual-polarization electromagnetic signal, comprising: a plurality of hybrids configured to receive the dual-polarization electromagnetic signal and a local oscillator signal, and to mix polarization components thereof to generate a plurality of mixed outputs, each representing a combination of polarization components of the dual-polarization electromagnetic signal and the local oscillator signal; a plurality of detectors; and a set of routing connections arranged according to a predetermined connection pattern to route the mixed outputs to the plurality of detectors such that each of the plurality of detectors receives a distinct combination of polarization components of the dual-polarization electromagnetic signal and the local oscillator signal, wherein the routing of the mixed outputs defines a linear transformation between the dual-polarization electromagnetic signal and electrical signals generated by the detectors, the linear transformation being unitary.

In another aspect, embodiments of this disclosure provide a computer readable storage medium, comprising one or more instructions, wherein when the one or more instructions are run on a computer, the computer performs any of the methods disclosed herein.

In another aspect, embodiments of this disclosure provide a non-transitory computer-readable medium storing instruction the instructions causing a processor in a device to implement any of the methods disclosed herein.

In another aspect, embodiments of this disclosure provide a device configured to perform any of the methods disclosed herein.

In another aspect, embodiments of this disclosure provide a processor, configured to execute instructions to cause a device to perform any of the methods disclosed herein.

In another aspect, embodiments of this disclosure provide an integrated circuit configure to perform any of the methods disclosed herein.

According to one aspect of this disclosure, there is provided a module comprising: one or more circuits for performing any of the methods disclosed herein.

According to one aspect of this disclosure, there is provided an apparatus comprising: one or more processors functionally connected to one or more memories for performing any of the methods disclosed herein.

According to one aspect of this disclosure, there is provided an apparatus configured to perform any of the methods disclosed herein.

In some embodiments the apparatus comprises one or more units configured to perform the above-described method.

According to one aspect of this disclosure, there is provided one or more non-transitory, computer-readable storage media comprising computer-executable instructions, wherein the instructions, when executed, cause at least one processing unit, at least one processor, or at least one circuits to perform any of the methods disclosed herein.

According to one aspect of this disclosure, there is provided one or more computer-readable storage media storing a computer program, wherein, when the computer program is executed by an apparatus, the apparatus is enabled to implement any of the methods disclosed herein.

According to one aspect of this disclosure, there is provided a computer program product including one or more instructions, wherein, when the instructions are executed by an apparatus, the apparatus is enabled to implement any of the methods disclosed herein.

According to one aspect of this disclosure, there is provided a computer program, wherein, when the computer program is executed by a computer, an apparatus is enabled to implement any of the methods disclosed herein.

According to one aspect of this disclosure, there is provided a system comprising a node for performing any of the methods disclosed herein.

This summary does not necessarily describe the entire scope of all aspects. Other aspects, features and advantages will be apparent to those of ordinary skill in the art upon review of the following description of specific embodiments.

### BRIEF DESCRIPTION OF THE FIGURES

In the accompanying drawings, which illustrate one or more example embodiments:

FIG. 1 is a schematic diagram of a prior art conventional coherent receiver architecture employing a local oscillator (LO) signal with a fixed polarization state, according to an example embodiment.

FIG. 2 is a schematic diagram of a prior art coherent receiver configuration employing balanced photodiodes (BPDs) for polarization-diverse detection, according to an example embodiment.

FIG. 3 is a schematic diagram of a prior art symmetric polarization-diverse coherent receiver architecture, according to an example embodiment.

FIG. 4A is a block diagram of a local-oscillator-polarization-insensitive integrated coherent receiver (LO-PI ICR) architecture using four single-ended photodetectors, according to an example embodiment.

FIG. 4B is a schematic diagram of an example optical connection pattern from the outputs of four 90° optical hybrids to photodetector inputs for the architecture of FIG. 4A, according to an example embodiment.

FIG. 4C is a mapping table identifying the optical signal content at each photodetector-side port in the architecture of FIG. 4A, according to an example embodiment.

FIG. 5 is a diagram of a 90° optical hybrid used in the mapping of FIG. 4C, according to an example embodiment.

FIG. 6A is a block diagram of a LO-PI ICR architecture employing four balanced photodetector pairs, according to an example embodiment.

FIG. 6B is a schematic diagram of 16 one-to-one ICR optical connection mapping from the outputs of four 90° optical hybrids to photodetector inputs for the architecture of FIG. 6A, according to an example embodiment.

FIG. 6C is a mapping table identifying the optical signal content at each photodetector-side port in the architecture of FIG. 6A, according to an example embodiment.

FIG. 7 is a set of simulation results illustrating SNR and constellation stability for the LO-PI ICR architecture of FIG. 6A, according to an example embodiment.

FIGS. 8A-8C are schematic diagrams of example alternative optical connection schemes for implementing the LO-PI ICR architecture with eight photodetectors, according to example embodiments.

FIGS. 9A-9B are graphs showing bit-error rate (BER) performance based on sweep statistics for the LO-PI ICR architecture of FIG. 6A under back-to-back test conditions across multiple transmission configurations.

FIG. 9C is a graph showing BER performance based on random statistics for the LO-PI ICR architecture of FIG. 6A over multiple test cases.

FIG. 9D is a graph showing SNR performance based on random statistics corresponding to the BER test of FIG. 9C.

### DETAILED DESCRIPTION

The present disclosure relates to coherent optical receivers and associated signal processing techniques employed in optical communication systems. The following description introduces key technical concepts and components relevant to the disclosed embodiments, providing a high-level context for the detailed discussion that follows.

An Integrated Coherent Receiver (ICR) is a useful component in modern coherent optical communication systems. It enables recovery of both amplitude and phase information from modulated optical signals, including those encoded with advanced modulation formats such as quadrature amplitude modulation (QAM). A typical ICR includes a polarization beam splitter (PBS) to separate an incoming optical signal into orthogonal polarization components, a set of optical 90° hybrids to mix the optical signal and the rotated laser signal, and balanced photodetectors to convert the optical signals into corresponding electrical signals. The resulting electrical signals are amplified by transimpedance amplifiers (TIAs) and digitized by ADCs for subsequent digital signal processing.

Coherent detection in such systems is enabled by a LO laser, which serves as a phase reference for optical mixing in the ICR. This architecture supports the use of higher-order modulation formats, delivering high spectral efficiency and compatibility with high-capacity transmission networks. ICRs are deployed in a wide range of scenarios, from long-haul fiber links to metro and access networks, and can be adapted to balance performance, power consumption, and implementation cost.

Self-Coherent (SCH) receivers have emerged as an alternative architecture, particularly suited to short-reach optical links. In these designs, the LO reference is derived from the transmitted optical signal itself-either co-propagated with the data signal or delivered over a separate path-eliminating the need for a separate LO laser at the receiver. SCH receivers can achieve improved sensitivity and spectral efficiency compared to intensity-modulation direct-detection (IMDD) systems, while reducing complexity relative to conventional coherent receivers, making them attractive for cost-sensitive environments such as data center interconnects.

In conventional coherent systems, accurate signal recovery often depends on managing the polarization state of the LO relative to the received signal. Variations in polarization (caused by environmental factors, fiber movement, or birefringence) can degrade detection performance. Existing solutions typically involve active polarization tracking mechanisms, polarization-maintaining fibers, or additional polarization-diversity receiver structures, each introducing trade-offs in complexity, cost, or scalability.

A LO-PI ICR structure is a class of coherent receiver architecture designed to operate independently of the LO polarization state. By mitigating or eliminating the requirement for strict polarization alignment, LO-PI designs can maintain stable performance across varying conditions, potentially simplifying system integration and improving robustness in dynamic optical networks.

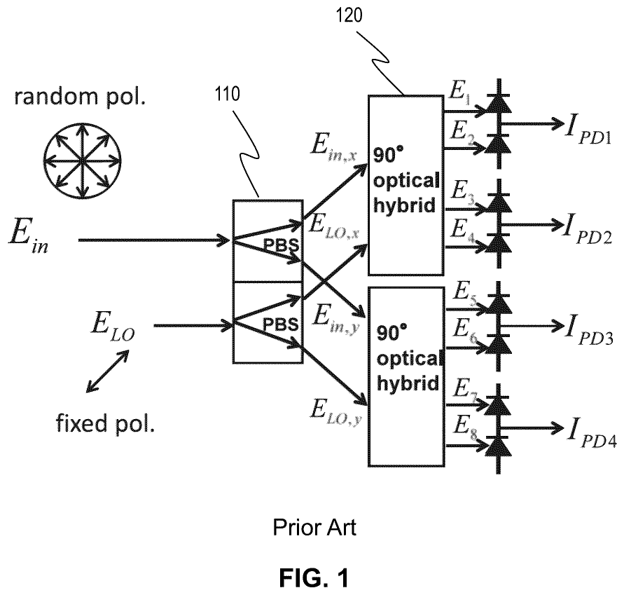

FIG. 1 illustrates an example of a prior art conventional coherent receiver architecture employing a LO signal with a fixed polarization state. The incoming optical signal Eᵢₙ, which may have an arbitrary or time-varying polarization, is received at a first PBS 110. The PBS separates Eᵢₙ into two orthogonal polarization components, denoted E_{in,x} and E_{in,y}.

The LO signal E_{LO}, maintained in a fixed polarization state (for example, through the use of polarization-maintaining fiber), is provided to a second PBS 110. This PBS separates E_{LO} into orthogonal components E_{LO,x} and E_{LO,y}. Each signal polarization component E or E_{in,x} is paired with a corresponding LO component E_{LO,x} or E_{LO,y} and directed to a respective 90-degree optical hybrid 120.

Within each optical hybrid 120, the paired signal and LO components are optically mixed to generate four phase-shifted combinations. These optical outputs are detected by respective balanced photodetectors PD₁ through PD₄, producing electrical currents IPD₁-IPD₄ for each polarization branch.

In such receivers, polarization-maintaining fibers are often employed to ensure that the LO polarization state is preserved from the laser source to the receiver, thereby enabling balanced LO power delivery to both polarization branches and reducing polarization-induced fading. However, this approach can be impractical in certain deployment scenarios, such as self-coherent systems where the LO is transmitted over a separate fiber, due to environmental perturbations and fiber movement that alter polarization states.

To mitigate LO polarization variations, some prior systems incorporate active polarization tracking circuits, which adjust the LO polarization at the receiver using optical phase shifters or similar control elements. These solutions, however, are limited in tracking speed (typically on the order of a few hundred radians per second) and may be insufficient in links experiencing rapid polarization fluctuations. Furthermore, they increase system cost and optical complexity, making them less attractive for short-reach, cost-sensitive applications.

Other known approaches seek to enhance LO polarization tolerance by adding redundancy to the receiver, such as additional optical hybrids and photodetectors to implement polarization-diverse processing paths. While these configurations can improve performance under varying polarization states, they also increase the optical and electrical hardware footprint, as well as the number of required ADCs, thereby raising implementation complexity and cost.

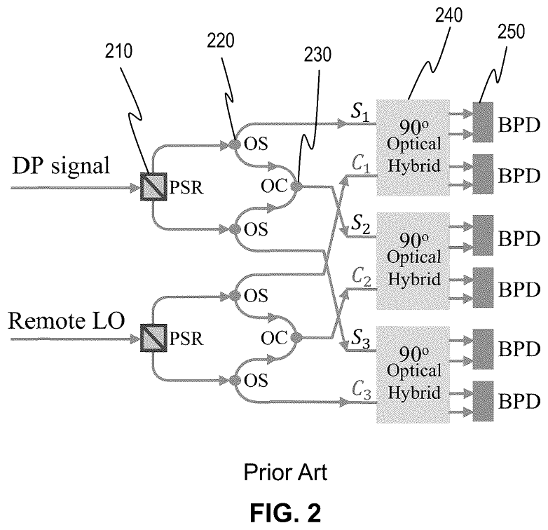

FIG. 2 illustrates another example of a prior art coherent receiver configuration employing balanced photodiodes (BPDs). In this arrangement, a dual-polarization (DP) optical signal and a remote LO are processed in parallel. Each of the DP signal and LO inputs is passed through a polarization splitter-rotator (PSR) 210, which separates the input into orthogonal polarization components and rotates one component to match the orientation of the other. The resulting outputs are then directed through optical splitters (OS) 220 and optical couplers (OC) 230 to form three distinct signal paths S₁, S₂, S₃ and three corresponding LO paths C₁, C₂, C₃.

Each signal path is mixed with its corresponding LO path using a dedicated 90° optical hybrid 240. The optical outputs from the hybrids are detected by balanced photodiodes 250, converting them into electrical signals for further processing. This multi-branch arrangement supports polarization-diverse detection and can improve tolerance to LO polarization variation. However, it increases the number of optical hybrids, photodiodes, and electrical channels, leading to greater hardware complexity, footprint, and cost.

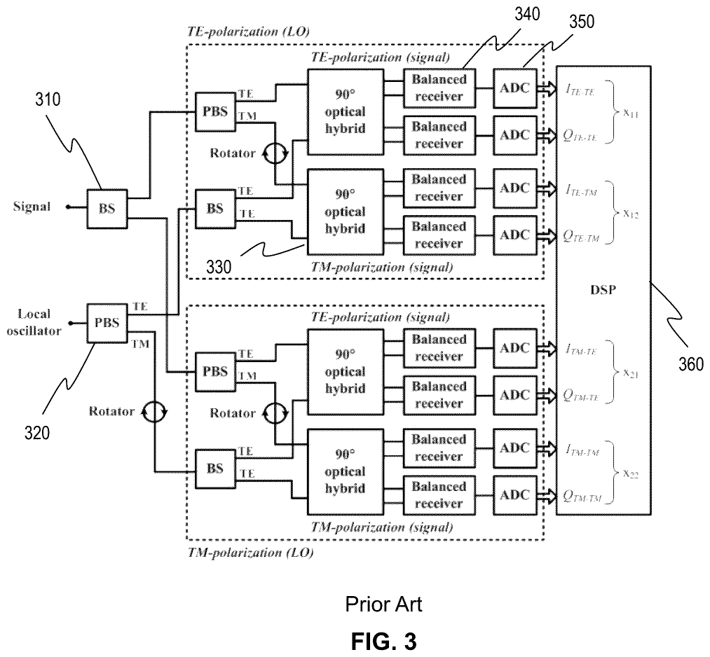

FIG. 3 shows a more complex example of a prior art symmetric polarization-diverse coherent receiver architecture. In this design, the incoming signal and LO are each split into transverse electric (TE) and transverse magnetic (TM) polarization components. In the signal path, this is performed using a beam splitter (BS) 310, while in the LO path it is performed using a PBS 320. Polarization rotators are used to align the orientations of the separated components. The TE and TM components are then routed, via additional beam splitters and polarization rotators, to dedicated 90° optical hybrids 330.

Each optical hybrid mixes a specific combination of signal and LO polarizations, such as TE-TE, TE-TM, TM-TE, and TM-TM, to produce the corresponding components. These components are detected by balanced receivers and digitized by ADCs 350. The digitized data is processed by a digital signal processor (DSP) 360 to reconstruct the transmitted data symbols.

This symmetric, fully polarization-diverse arrangement can provide robust signal recovery regardless of the LO polarization state. However, it typically requires sixteen photodiodes and more than four ADCs, significantly increasing cost, power consumption, and the complexity of optical packaging and electrical routing. These characteristics can make such an architecture less suitable for short-reach, low-cost applications where simplicity and efficiency are priorities.

As described above, existing coherent receiver architectures often require active polarization control, polarization-maintaining fiber infrastructure, or redundant detection branches in order to address variations in the polarization state of the LO. While these approaches can improve tolerance to polarization changes, they generally increase component count, particularly photodiodes and ADCs, and can impose higher cost, greater power consumption, and more complex optical and electrical packaging. Moreover, the detection performance in such systems may still vary with changes in LO polarization, limiting robustness in dynamic operating environments.

The present disclosure introduces a local-oscillator-polarization-insensitive integrated coherent receiver (LO-PI ICR) architecture that addresses these limitations while maintaining compatibility with established integrated photonics platforms. In one aspect, the LO-PI ICR is configured to perform coherent detection without sensitivity to the polarization state of either the LO or the incoming signal, thereby improving system stability and performance in scenarios where polarization conditions change rapidly or unpredictably.

The objectives of the present disclosure include but not limited to:
(a) providing an ICR architecture that uses conventional 90-degree optical hybrids implemented in waveguide technology, thereby avoiding the need for custom or non-standard optical mixing components;
(b) limiting the required number of ADCs to four, as in a conventional dual-polarization coherent receiver, so as not to increase backend complexity;
(c) supporting a photodetector (PD) count of between four and eight, but in all cases not exceeding the PD count of a conventional dual-polarization coherent receiver, thereby preserving optical packaging and routing feasibility;
(d) ensuring that the receiver sensitivity is substantially invariant to the polarization state of both the LO and the received signal; and
(e) producing an optical space-polarization-coded channel that can be represented by a unitary matrix, allowing for efficient digital equalization without noise enhancement.

According to one aspect of the present disclosure, an apparatus for coherent detection of a dual-polarization optical signal is provided. The apparatus comprises a plurality of optical hybrids configured to receive the dual-polarization optical signal and a local oscillator (LO) signal, and to optically mix polarization components thereof to generate a plurality of mixed optical outputs. In some embodiments, the optical hybrids are conventional 90° optical hybrids implemented in waveguide technology, thereby allowing the design to remain compatible with high-volume photonic integration processes.

The plurality of optical hybrids are arranged to perform optical space-polarization coding, in which each mixed optical output represents a distinct combination of polarization components of the dual-polarization optical signal and the LO signal. By performing cross-mixing across both polarization axes, a balanced distribution of polarization components can be produced among the detection branches. The resulting combinations define a linear transformation between the dual-polarization optical signal and the corresponding electrical outputs generated by photodetection. The transformation is mathematically unitary, thereby enabling stable and low-complexity equalization in the DSP without introducing noise enhancement.

As used herein, a matrix is “unitary” or “mathematically unitary” if its conjugate transpose equals its inverse, i.e., U^{H}U=UU^{H}=I, where U^{H} denotes the Hermitian transpose of U and I denotes the identity matrix. This property preserves orthogonality between the transformation's column vectors and maintains a constant total gain. In the present disclosure, the unitary nature of the transformation defined by the optical routing enables the combined optical and fiber channel response to be equalized jointly without polarization-dependent distortion, thereby allowing coherent detection that is insensitive to the polarization state of the local oscillator signal across all described photodetector configurations.

A set of optical routing connections is provided according to a predetermined connection pattern, the routing connections coupling the mixed optical outputs from the plurality of optical hybrids to a plurality of PDs. In some embodiments, the PDs may be implemented as single photodiodes, while in other embodiments they may be arranged in balanced pairs. When balanced pairs are used, the differential currents may be coupled to TIAs for amplification prior to digitization by the associated ADCs.

In one embodiment, four 90° optical hybrids may be used, and the mixed optical outputs are routed to polarization beam combiners (PBCs) prior to photodetection. Each PBC can combine two orthogonal polarization components into a single output, which is then detected by a PD or PD pair.

In certain implementations, the architecture can be extended by incorporating additional 90° optical hybrids into the signal path. These additional hybrids contribute to enhanced spatial diversity and redundancy, further improving uniformity of response across polarization states and reducing susceptibility to LO polarization fading. In this context, the LO polarization state is modeled as a fading channel, and the redundancy introduced by the space-polarization coding compensates for such variations.

The use of conventional integrated photonics components, such as 90° optical hybrids, beam splitters, and polarization beam combiners, ensures that the proposed architecture is compatible with established manufacturing processes and scalable for deployment in short-reach and cost-sensitive optical communication systems. By combining LO polarization insensitivity, a unitary space-polarization-coded transformation, and compatibility with photonic integration, the disclosed apparatus addresses the practical constraints of coherent optical receiver deployment while improving robustness and simplifying overall system design.

Specifically, using a Jones vector representation of the received LO as [Lₓ,L_{y}], the optical routing from the 90° hybrids to the PDs may be selected so that the resulting LO-channel transfer matrix H is unitary. This property ensures that the LO channel, when cascaded with the transmission fiber channel, can be equalized jointly using a linear digital equalizer.

Here, a space-polarization-coded arrangement means that outputs from multiple optical hybrids are selectively connected to PDs so as to jointly encode spatial and polarization information into the detected components. With an appropriate connection pattern, the columns of the LO-channel matrix become orthogonal, yielding a unitary transformation and thereby enabling stable DSP equalization that is inherently insensitive to LO state of polarization (SOP).

For example, for the balanced-PD implementation, the four real-valued baseband outputs (after the hybrids and PDs) can be written as follows. Here, I_{X} and Q_{X} denote, respectively, the in-phase and quadrature outputs associated with the first detected tributary (labeled “X”), and I_{Y} and Q_{Y} denote the in-phase and quadrature outputs associated with the second detected tributary (labeled “Y”). In these expressions, Re{⋅} and Im{⋅} denote the real and imaginary parts, Sₓ, S_{y} are the complex envelopes of the received signal in the x- and y-polarization bases, Lₓ, L_{y} are the corresponding LO components, and (⋅)* denotes complex conjugation:

$${l}_{X} = R e \{ {S}_{x} {L}_{y}^{*} \} - R e \{ {S}_{y} {L}_{x}^{*} \} , \qquad ( 1 )$$

$${Q}_{X} = Im \{ {S}_{x} {L}_{y}^{*} \} + Im \{ {S}_{y} {L}_{x}^{*} \} ,$$

$${I}_{Y} = R e \{ {S}_{x} {L}_{x}^{*} \} + R e \{ {S}_{y} {L}_{y}^{*} \} ,$$

$${Q}_{Y} = Im \{ {S}_{x} {L}_{x}^{*} \} - Im \{ {S}_{y} {L}_{y}^{*} \}$$

After transimpedance amplification and digitization, these pairs are naturally grouped into complex outputs by

$${S}_{x}^{o} {=}^{Δ} {I}_{X} + {jQ}_{x} and {S}_{y}^{o} {=}^{Δ} {jQ}_{Y}$$

(with j=\sqrt{−1}). Using the identities above, this gives the explicit complex-form relations:

$${S}_{x}^{o} = {S}_{x} {L}_{y}^{*} - {( {S}_{y} {L}_{x}^{*} )}^{*} , \qquad ( 2 )$$

$${S}_{y}^{o} = {S}_{x} {L}_{x}^{*} + {( {S}_{y} {L}_{y}^{*} )}^{*} .$$

Equations (2) can be written compactly in matrix form as

$$[ \begin{matrix}{S}_{x}^{o} \\ {S}_{y}^{o}\end{matrix} ] = [ \begin{matrix}{L}_{y}^{*} & - {L}_{x} \\ {L}_{x}^{*} & {L}_{y}\end{matrix} ] [ \begin{matrix}{S}_{x} \\ {S}_{y}^{*}\end{matrix} ] . \qquad ( 3 )$$

The unitarity of

$$H = [ \begin{matrix}{L}_{y}^{*} & - {L}_{x} \\ {L}_{x}^{*} & {L}_{y}\end{matrix} ]$$

follows directly. Taking the Hermitian transpose and multiplying, it is obtained that:

$${H}^{H} H = [ \begin{matrix}{L}_{y} & {L}_{x} \\ - {L}_{x}^{*} & {L}_{y}^{⋆}\end{matrix} ] [ \begin{matrix}{L}_{y}^{*} & - {L}_{x} \\ {L}_{x}^{*} & {L}_{y}\end{matrix} ] = [ \begin{matrix}{‖ {L}_{y} ‖}^{2} + {‖ {L}_{x} ‖}^{2} & 0 \\ 0 & {‖ {L}_{y} ‖}^{2} + {‖ {L}_{x} ‖}^{2}\end{matrix} ] \qquad ( 4 )$$

This confirms that H preserves orthogonality and has constant gain (∥L_{y}∥²+∥Lₓ∥²), allowing the fiber channel and LO channel to be equalized simultaneously with a 4×4 multiple-input multiple-output (MIMO) linear equalizer.

This mathematical structure is analogous to the Alamouti space-time block code, in which orthogonal signal patterns are transmitted across two antennas to provide diversity over fading channels. In the LO-PI ICR, space-polarization coding creates orthogonal mixing patterns with respect to the LO polarization states, thereby providing diversity and robustness in optical channels subject to LO polarization fading. As long as the unitary matrix condition is satisfied, the receiver remains insensitive to the LO polarization state, and this condition can be maintained across different hardware configurations.

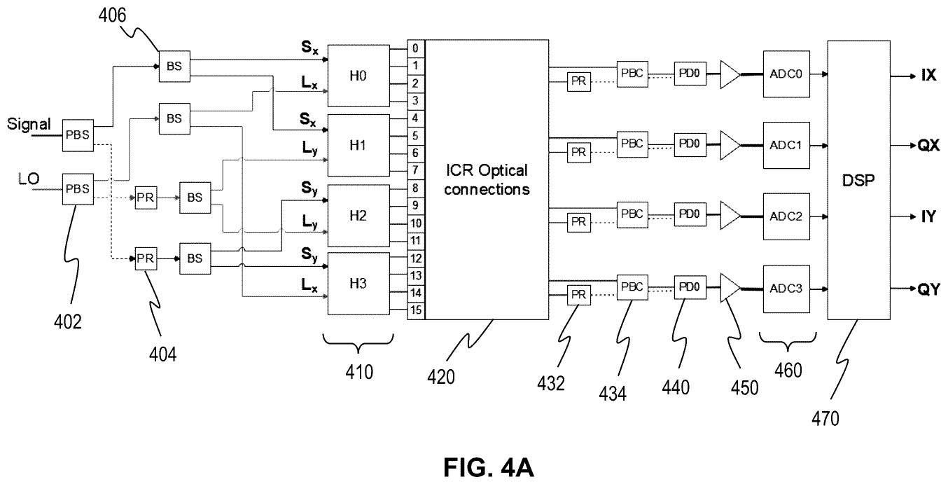

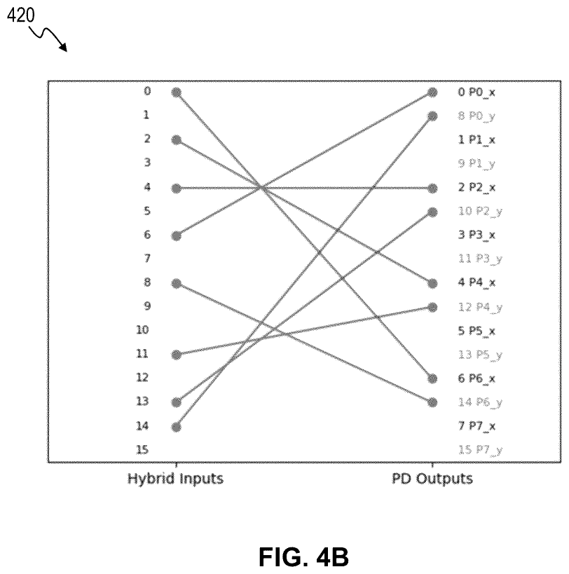

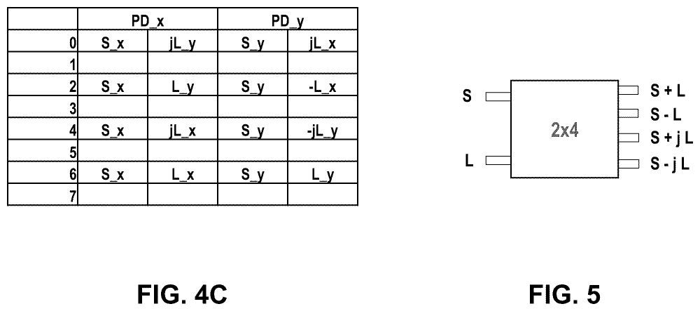

FIG. 4A illustrates an example architecture described herein. The architecture includes four hybrid blocks H0 to H3, each configured to receive respective combinations of signal components S and LO components L in different polarization orientations. In this embodiment, the signal and LO inputs are first separated into orthogonal polarizations by polarization beam splitters (PBSs 402). On the LO branch (and where applicable), the polarization rotators (PRs 404) rotate TM-polarized components into the TE basis so that subsequent mixing can be performed in a common polarization mode. After this rotation, the beam splitters (BSs 406) distribute the TE-polarized components to the inputs of the four hybrids. In the optical domain prior to photodetection, the solid lines in FIG. 4A denote TE-polarized paths, while the dashed lines denote paths carrying TM polarization prior to rotation by the PRs 404.

The routing is arranged so that the signal components Sₓ and S_{y}, and the LO components Lₓ and L_{y}, are distributed across the four hybrid blocks 410. Each hybrid block is implemented as a 90° optical hybrid in this example, producing mixed optical outputs that represent distinct combinations of the incoming signal and LO polarization components. These outputs are connected through an optical routing network (ICR optical connections 420) to polarization beam combiners (PBCs 434), with intervening polarization rotators (PRs 432) where needed to match the required polarization basis at the PBC inputs. Each PBC output is directed to a photodetector (PD0 440), which may be implemented as a single photodiode or as part of a balanced detector pair. The electrical outputs from the PDs are coupled to transimpedance amplifiers 450 and then digitized by the corresponding analog-to-digital converters (ADC0 to ADC3 460). After being processed by a subsequent digital signal processor (DSP 470), the electrical signals Iₓ, Qₓ, I_{y}, and Q_{y} are produced.

In this embodiment, the architecture enables coherent detection of dual-polarization optical signals while using only four ADCs. By maintaining the ADC count at four, the architecture can reduce backend complexity compared to prior arrangements that require additional parallel detection branches, while still enabling recovery of all dual-polarization signal components.

A further aspect of this embodiment is its reduced sensitivity to the polarization state of the LO. In many conventional coherent receivers, variations in LO polarization can lead to unbalanced mixing in the hybrids and degraded receiver performance, particularly in environments with time-varying polarization. In the present configuration, the optical routing and mixing scheme distributes the LO polarization components across the hybrid blocks in a balanced manner, mitigating the impact of LO polarization variations on the detected signal quality.

These optical connections can be characterized by a set of coefficients that define the mapping between each hybrid output and each PD input. Such coefficients describe the underlying linear transformation that relates the dual-polarization optical signal to the generated electrical signals, and they form the basis for modeling the optical routing in the context of space-polarization diversity. The unitary nature of the transformation supports efficient DSP-based equalization without noise enhancement.

It is noted that the outputs from the PBSs at 402 include both TE and TM polarization modes. In a configuration where all 90° optical hybrids operate in the TE mode, TM components are first rotated into the TE basis by polarization rotators (PRs 404) before being routed to the beam splitters. Likewise, to obtain Y-polarized signal inputs required at certain PDs, additional PRs 432 are used at the outputs of the 90° hybrids before connection to the PBCs.

FIG. 4B illustrates an example of the ICR optical connections 420 shown in FIG. 4A for the embodiment employing four PDs. In this example, the hybrid inputs on the left correspond to the sixteen output ports of the four 90° optical hybrids (H0-H3) in FIG. 4A. Of these ports, eight are active (“hot”) ports that carry specific combinations of signal (S) and local oscillator (LO) polarization components, while the remaining eight are inactive or “dummy” ports that do not carry useful mixed-signal content but are inherent to the optical hybrid structure. Because

The connection pattern depicted in FIG. 4B represents an example optical routing implemented by the ICR optical connections 420. These optical paths direct the hybrid outputs to the PD-side ports shown on the right, each labeled with an index (P0-P7) and a polarization suffix (“_x” or “_y”) indicating the polarization component before combination in a PBC. The arrangement allows that each PD ultimately receives a distinct space-polarization combination of the input signals.

This mapping pattern supports the formation of a mathematically unitary channel matrix between the optical inputs and the detected electrical signals, enabling stable DSP equalization without noise enhancement. In the embodiment shown, the eight PD-side ports may correspond to either four balanced PD pairs or, alternatively, eight single-ended PDs, as also reflected in the PD and TIA arrangement in FIG. 4A. The configuration enables recovery of the full in-phase (I) and quadrature (Q) components for both polarizations of the signal while maintaining LO polarization insensitivity.

In certain implementations, balanced PDs may be advantageous to suppress signal-signal beating and cancel common-mode noise, thereby improving the signal-to-noise ratio (SNR) prior to digitization by the ADCs. This arrangement may enhance the quality of the recovered coherent signal components while maintaining compatibility with high-volume integrated photonics manufacturing processes and without increasing the number of ADCs beyond the four typically used in conventional dual-polarization coherent receivers.

FIG. 4C shows an example mapping table that describes the signal content received at each PD-side port after optical routing by the ICR optical connections 420. The columns labeled “PD_x” and “PD_y” indicate the orthogonal polarization channels at the outputs of the polarization beam combiners, while the rows correspond to the respective PD indices (0-7 in FIG. 4B). Each table entry denotes the optical signal component present at that port, expressed in terms of the signal (S) and local oscillator (L) polarization components (subscripts x and y) with their associated complex coefficients (e.g., j to indicate a ±90° phase shift). Negative signs reflect the relative phase relationships between the mixed components. In this example, the table includes both S- and L-polarized inputs in various combinations, illustrating how the hybrid mixing and routing produce the distinct signal states needed for space-polarization diversity.

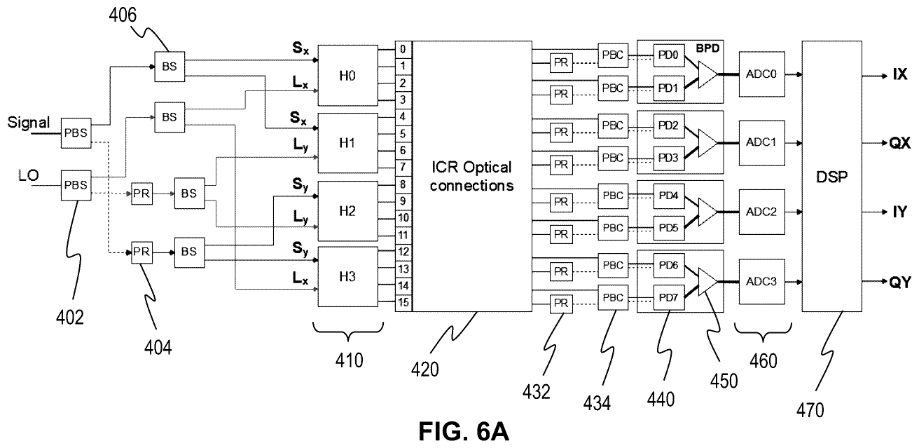

The arrangement in FIG. 4C is consistent with the 90° optical hybrid operation shown in FIG. 5. As depicted in FIG. 5, each 90° hybrid accepts two optical inputs, one for the signal (S) and one for the LO (L), and produces four optical outputs: S+L, S−L, S+jL, and S−jL, corresponding to the different interference states between the signal and LO. In the illustrated embodiment, only a subset of these outputs is actively routed for detection, with the remaining outputs either unused or connected to inactive (“dummy”) ports inherent to the hybrid structure (e.g., the ports 1, 3, 5, and 7 are inactive according to FIGS. 4B and 4C). When implemented in the architecture of FIG. 4A, the selected outputs are routed according to the connection pattern in FIG. 4B and assigned as indicated in the mapping of FIG. 4C, such that each photodetector receives a distinct space-polarization combination suitable for subsequent digital equalization.

The mapping illustrated in FIGS. 4B-4C shows one example of how the outputs of the 90° optical hybrids can be routed to the photodetector inputs. In this example, each hybrid produces four outputs, S+L, S−L, S+jL, and S−jL. The optical routing is selected so that each photodetector receives a distinct space-polarization combination of the mixed components, with the set of optical paths forming a mathematically unitary transformation between the dual-polarization optical inputs and the detected electrical outputs. This unitary property supports stable DSP equalization without noise enhancement and can be achieved by distributing the mixed polarization components evenly across the detection branches. While the illustrated mapping and hybrid configuration represent one implementation, other routing patterns, phase conventions, or polarization bases may be used, provided that the resulting transformation preserves the unitary property.

In addition, it should be understood that, the configuration shown in FIGS. 4A-4C is provided as one illustrative example of implementing the space-polarization-coded receiver architecture. Variations are possible in which certain components, such as the number of hybrid blocks, the specific arrangement of polarization rotators, or the inclusion of polarization beam combiners, may be modified, omitted, or replaced by functionally equivalent elements. The routing pattern, number of detection channels, and specific optical components can also differ from those shown, provided that the mixed optical outputs are routed to the photodetectors according to a connection pattern that defines a mathematically unitary transformation between the dual-polarization optical signal and the corresponding electrical outputs. Subsequent ancillary components, such as transimpedance amplifiers, analog-to-digital converters, and digital signal processing stages, are shown here for completeness but are not essential in the context of the disclosure.

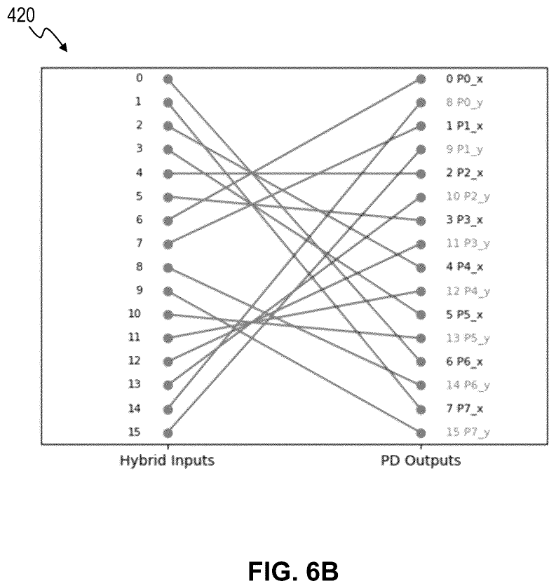

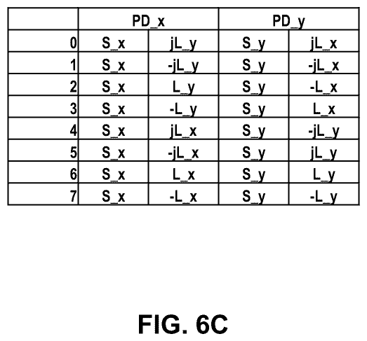

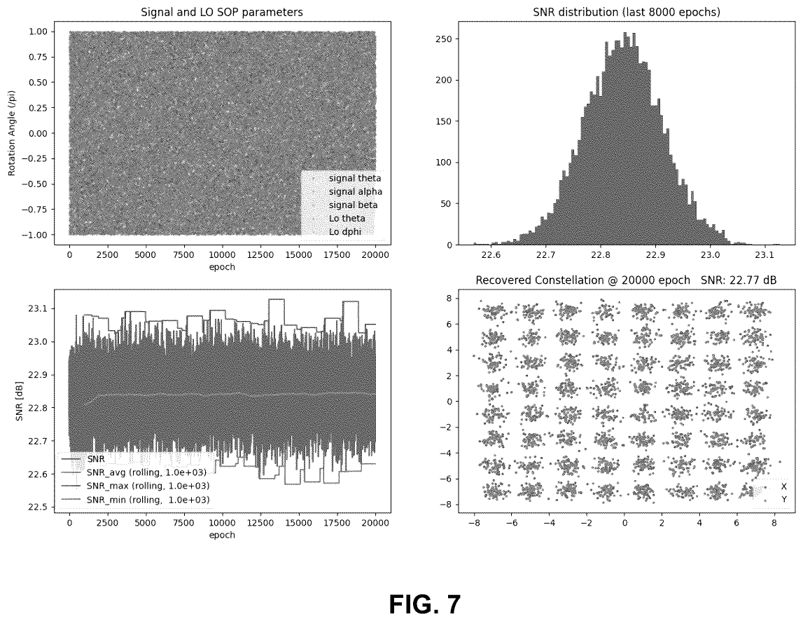

FIG. 6A illustrates another embodiment of the LO-polarization-insensitive integrated coherent receiver (LO-PI ICR) architecture, configured with four balanced photodetectors (BPDs), corresponding to a total of eight individual photodiodes (PD0-PD7 440). As in the embodiment of FIG. 4A, the signal and LO inputs are first separated into orthogonal polarizations by polarization beam splitters (PBSs 402). On the LO branch, polarization rotators (PRs 404) convert TM-polarized components into the TE basis so that subsequent mixing can be performed in a common polarization mode. After this rotation, beam splitters (BSs 406) distribute the TE-polarized components to the inputs of four 90° optical hybrids (H0-H3 410). In the optical domain prior to photodetection, the solid lines in FIG. 6A denote TE-polarized paths, while dashed lines indicate TM-polarized paths prior to rotation by the PRs 404.

Each hybrid block (H0-H3 410) receives respective combinations of the signal components Sₓ, S_{y} and LO components Lₓ, L_{y}, and produces four mixed optical outputs. These 16 outputs are passed to an optical routing network (ICR optical connections 420) that implements a one-to-one mapping from each hybrid output to a corresponding PD-side port. Polarization rotators (PRs 432) are inserted where needed to match the polarization basis required at the inputs of polarization beam combiners (PBCs 434), which merge orthogonal polarization components prior to photodetection.

The outputs of the PBCs are directed to the eight photodiodes (PD0-PD7 440), which are arranged in four balanced detector pairs (BPDs). Each balanced detector pair is connected to a transimpedance amplifier (TIA) stage 450, which serves as a current-differentiator to recover the differential signal corresponding to one of the in-phase (I) or quadrature (Q) components for a given polarization. The amplified electrical outputs are digitized by the corresponding analog-to-digital converters (ADC0-ADC3 460) and processed in the digital signal processor (DSP 470) to produce the recovered signal components Iₓ, Qₓ, I_{y}, and Q_{y}.

This embodiment extends the 4-PD configuration described with respect to FIG. 4A by incorporating balanced detection for each polarization channel, thereby improving common-mode noise rejection and SNR without increasing the ADC count beyond four. The balanced configuration can suppress signal-signal beating and enhance receiver linearity, making it well-suited for high-capacity short-reach links and space-division multiplexed systems. As with the earlier embodiment, the routing pattern implemented by the ICR optical connections 420 defines a mathematically unitary transformation between the dual-polarization optical inputs and the detected electrical outputs, supporting stable DSP equalization without noise enhancement.

FIG. 6B illustrates an example of the ICR optical connections 420 shown in FIG. 6A for the embodiment employing eight photodetectors (PD0-PD7) arranged as four balanced PD pairs. In this embodiment, the hybrid inputs on the left correspond to the sixteen output ports of the four 90° optical hybrids (H0-H3) in FIG. 6A. Unlike the embodiment of FIG. 4B, all sixteen hybrid outputs are active and carry distinct mixed combinations of the signal (S) and local oscillator (LO) polarization components. Each hybrid output is routed exactly once to a unique PD-side port shown on the right, labeled with an index (P0-P7) and a polarization suffix (“_x” or “_y”) to indicate the polarization component before combination in a polarization beam combiner (PBC). The 16 one-to-one ICR optical connection mapping ensures that the spatial and polarization diversity produced by the hybrids is completely utilized, with each PD receiving a distinct space-polarization combination.

The mapping pattern in FIG. 6B supports the formation of a mathematically unitary channel matrix between the dual-polarization optical inputs and the detected electrical signals, enabling stable DSP equalization without noise enhancement. By employing balanced PDs, the configuration also suppresses common-mode noise and improves signal fidelity, while preserving the LO polarization-insensitive properties of the LO-PI ICR. This arrangement maintains the same four-ADC backend complexity as the embodiment of FIG. 4A, while providing extended dynamic performance through enhanced detection robustness.

FIG. 6C shows an example mapping table that specifies the optical signal content received at each PD-side port after routing by the ICR optical connections 420. The columns labeled “PD_x” and “PD_y” denote the orthogonal polarization channels at the PBC outputs, while each row corresponds to the respective PD index (0-7 in FIG. 6B). Each table entry expresses the optical component present at that port in terms of the signal (S) and LO (L) polarization components (subscripts x and y), with j denoting a ±90° phase shift and a negative sign indicating a relative phase inversion. The table illustrates how the routing assigns each PD pair a complementary set of mixed polarization components, ensuring balanced in-phase and quadrature signal acquisition for both X and Y polarization bases.

The arrangement in FIG. 6C is consistent with the 90° optical hybrid operation shown in FIG. 5. In the embodiment of FIG. 6A, all four outputs from each hybrid are actively routed according to the pattern in FIG. 6B and assigned to PD ports as indicated in FIG. 6C, thereby achieving complete utilization of the mixed polarization states for subsequent digital equalization.

While the specific mapping shown in FIGS. 6B-6C represents one implementation, other routing patterns, phase conventions, or polarization bases may be used, provided that the resulting transformation remains unitary. Variations may also be made to the number of hybrids, the arrangement of polarization rotators and beam combiners, or the use of balanced versus single-ended PDs, without departing from the principles of the disclosed space-polarization-coded coherent receiver architecture.

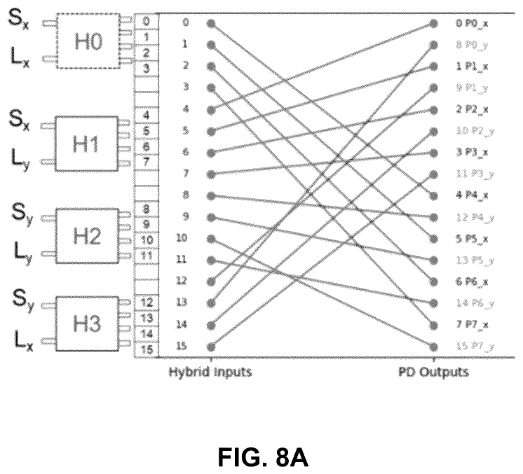

FIG. 7 presents simulated performance results for an example embodiment of the LO-PI ICR architecture described in FIG. 6A and implemented with the full-mapping optical connection scheme of FIGS. 6B-6C. The four charts collectively illustrate the receiver's operation under continuous, independent polarization variations of both the signal and the LO.

The top-left chart shows the evolution of the SOP parameters for the signal and LO over 20,000 epochs. The signal SOP is represented by three rotation parameters (signal theta, signal alpha, signal beta), while the LO SOP is represented by two rotation parameters (Lo theta, Lo dphi), each normalized to π. The dense distribution and continuous variation of all parameters demonstrate that the simulation models arbitrary, time-varying polarization states for both the signal and LO without active polarization control.

The top-right histogram depicts the distribution of the SNR over the last 8,000 epochs of the simulation. The SNR values are narrowly concentrated around approximately 22.8 dB, indicating that the full-utilization mapping of FIG. 6B maintains stable performance under the modeled polarization dynamics.

The bottom-left chart plots the SNR evolution across all 20,000 epochs, with the rolling average, maximum, and minimum SNR values calculated over a 1,000-epoch window. After an initial convergence phase, the SNR remains consistently near the average with minimal spread between the rolling maximum and minimum curves, confirming that the space-polarization-coded mapping of FIGS. 6B-6C supports robust, long-term signal recovery.

The bottom-right chart shows the recovered dual-polarization signal constellation at the 20,000th epoch for both X- and Y-polarization tributaries. The distinct and tightly clustered symbol groupings indicate that the receiver architecture of FIGS. 6A-6C, when combined with suitable DSP equalization, can accurately recover both polarizations of a dual-polarization signal even in the presence of arbitrary, independently varying LO polarization states.

As shown in FIG. 7, the simulation illustrates the advantages of employing the balanced photodetector configuration described above, in which four balanced PDs (eight individual PDs) are used in conjunction with current-differentiator transimpedance stages. In this way, the receiver can maintain stable operation under varying polarization conditions, while preserving the LO-polarization-insensitive properties of the LO-PI ICR. In addition, the balanced configuration extends the dynamic performance and robustness of the receiver without increasing the number of required ADC channels. Although the simulation demonstrates the beneficial results of the balanced configuration, the single-ended configuration of FIG. 4A can also deliver acceptable results when cost is a concern.

It should be understood that, while the embodiments of FIGS. 4A-4C and FIGS. 6A-6C illustrate specific cases with four single-ended photodetectors or four balanced photodetector pairs (eight photodetectors in total), the ICR optical connections 420 may also be implemented with intermediate photodetector configurations. In general, each of the four 90° optical hybrids produces four mixed optical outputs, and the architecture may employ between four and eight photodetectors to detect these outputs. In one implementation, four single-ended photodetectors may be used, each connected via a respective one-to-two optical routing to receive two of the mixed optical outputs. In another implementation, eight photodetectors may be used, each receiving a respective one of the mixed optical outputs in a full one-to-one mapping, as illustrated in FIGS. 6B-6C. In yet another variation, a mixed configuration may be employed in which certain channels are detected by single-ended photodetectors and others by balanced photodetector pairs. This hybrid approach can provide incremental performance between the four-photodetector and eight-photodetector configurations, allowing the possibility to balance manufacturing cost, integration complexity, and common-mode noise suppression according to system requirements, while still maintaining the LO-polarization-insensitive properties and unitary transformation supported by the ICR optical connections 420.

In some implementations, the coherent optical receiver described above may be integrated within a coherent optical transceiver. The transceiver may include a transmitter configured to generate and transmit a dual-polarization optical signal and a LO signal, either over the same or separate optical paths. The receiver portion of the transceiver may be implemented using the architecture shown in FIG. 4A or FIG. 6A, incorporating the optical routing provided by the ICR optical connections 420. This arrangement enables coherent detection of the transmitted signal using the shared LO, supporting self-coherent operation and reducing the number of lasers required at the receiver. Integrating the LO-PI ICR within a transceiver module may further reduce power consumption, component count, and system complexity, making the module suitable for short-reach and high-capacity optical interconnects, such as data center applications or space-division multiplexed systems.

The foregoing description has set out example embodiments of the LO-PI ICR architecture implemented using both single-ended and balanced photodetector structures. In each case, the optical connection scheme is selected so that the resulting LO-channel transfer function satisfies a unitary matrix condition. Maintaining this unitary property enables polarization-insensitive operation and supports stable digital equalization in the presence of varying LO polarization states. To further illustrate the underlying working principle of such architectures, the following discussion provides a mathematical formulation of the receiver operation and associated calculations.

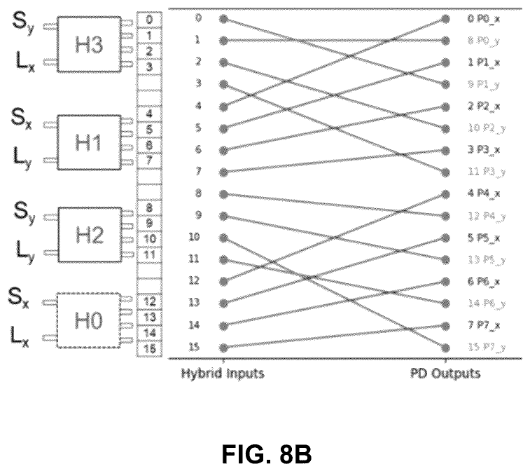

FIGS. 8A-8C illustrate three example optical connection schemes for implementing the LO-PI ICR architecture using eight PDs. In each configuration, four 90° hybrids (H0-H3) receive combinations of the x- and y-polarized components of the signal (Sₓ, S_{y}) and the LO (Lₓ, L_{y}), and generate sixteen hybrid outputs labeled 0-15. These hybrid outputs are routed to the PD input ports P0_x through P7_x and P0_y through P7_y according to the illustrated mappings.

In FIG. 8A, each hybrid is assigned a specific input pairing (e.g., H0 receives Sₓ and Lₓ, H1 receives Sₓ and L_{y}, etc.), and the output fibers or waveguides are routed so that all 16 hybrid outputs are used exactly once. The cross-connection pattern can ensure that each PD receives a unique spatial-polarization combination, preserving the orthogonality of the LO-channel matrix.

In FIG. 8B, the same set of signal and LO inputs are applied to the hybrids, but the mapping from the hybrid outputs to the PDs is permuted. This alternative routing still ensures one-to-one usage of all hybrid outputs and maintains the space-polarization diversity required for polarization-insensitive operation. Such rearrangement can be advantageous for optimizing photonic packaging, routing constraints, or integration with other components.

In FIG. 8C, the hybrid assignments and output-to-PD routing are further rearranged, demonstrating that the space-polarization-coded architecture can be realized through multiple physical layouts. Again, each of the 16 hybrid outputs is connected to a unique PD input, maintaining the structural property that yields a unitary LO-channel transfer matrix.

In all three embodiments shown in FIGS. 8A-8C, the mapping preserves the mathematical conditions needed for the LO-channel matrix to remain unitary, enabling the fiber channel and LO channel to be jointly equalized via DSP without dependence on the LO state of polarization. This flexibility in connection schemes highlights the adaptability of the LO-PI ICR design to different photonic integration and packaging requirements, while ensuring consistent coherent performance under arbitrary and varying signal and LO polarization conditions.

From a system perspective, such receiver configurations align well with anticipated trends in short-reach coherent systems for Data Center Interconnect (DCI) and Data Center Network (DCN) applications. The ability to realize self-coherent architectures that limit the number of required lasers, potentially to a single shared LO, offers significant reductions in cost, power consumption, and complexity, especially when paired with multi-lane or space-division multiplexing (SDM) technologies.

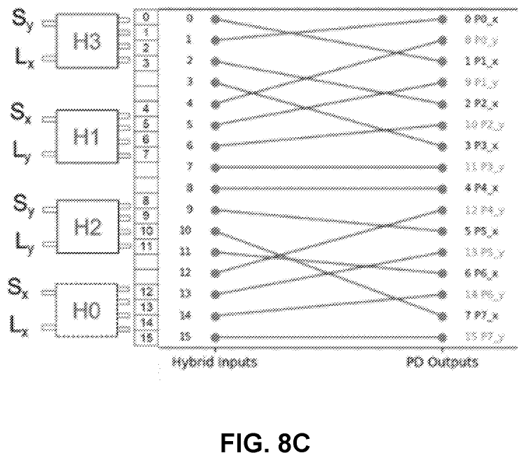

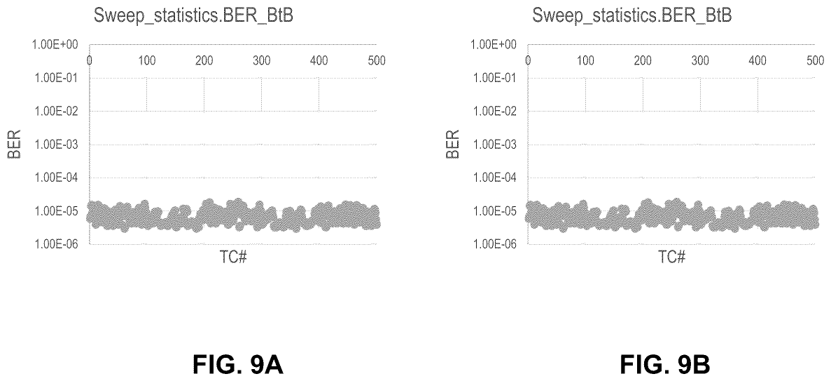

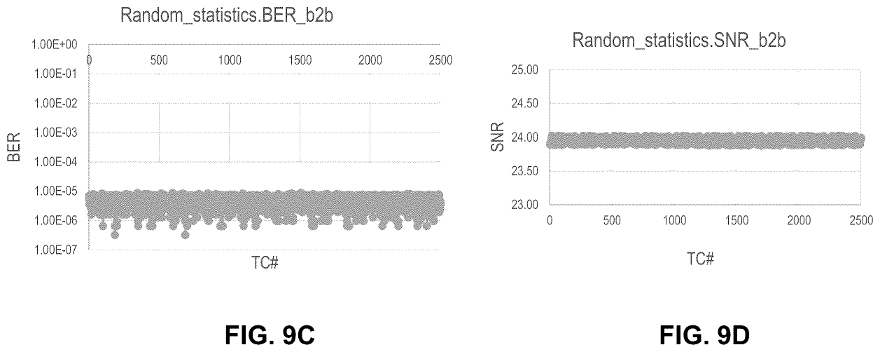

FIGS. 9A-9D present bit-error rate (BER) and SNR performance results obtained from simulations of the LO-PI ICR architecture of FIG. 6A under various operating conditions, demonstrating its polarization-insensitive coherent detection capability. In all cases, the space-polarization-coded LO arrangement maintains a unitary LO-channel matrix, allowing stable DSP equalization without polarization tracking.

FIGS. 9A and 9B illustrate back-to-back BER performance (sweeping statistics) for two representative test cases across 500 transmission configurations (TC #). The BER values remain consistently on the order of 10⁻⁵ or better, indicating stable receiver operation and negligible variation with changing LO and signal polarization states.

FIG. 9C shows BER performance (random statistics) for a back-to-back link, tested over 2500 cases. The BER values remain below approximately 10⁻⁵, confirming that the DSP equalizer can effectively compensate for both the fiber channel and LO channel jointly. FIG. 9D presents the corresponding SNR performance (random statistics) for the same test, demonstrating a stable SNR around 24 dB across all cases, further validating the robustness of the architecture against SOP variations.

These results confirm that the LO-PI ICR architecture achieves consistently low BER and stable SNR over a wide range of polarization and power conditions without the need for polarization tracking, meeting performance requirements for short-reach DCI and DCN applications.

From a deployment perspective, the described architecture is suited to meet the requirements of emerging high-capacity optical network applications, including 1.6 T long-reach (LR) and zero-dispersion (ZR) links in DCI and DCN environments. By supporting self-coherent receiver designs that can operate with a reduced number of lasers, and by enabling compatibility with parallel lane or SDM approaches, the disclosed LO-PI ICR architecture may facilitate cost-effective implementation while maintaining performance levels appropriate for next-generation optical systems.

The market for such technologies is expected to expand with increasing adoption of high-capacity, short- and medium-reach links. The disclosed LO-PI ICR is well aligned with this growth due to its ability to eliminate certain conventional receiver components, such as separate local oscillators, and to operate in self-coherent configurations without polarization controllers. The architecture is further compatible with SDM-based transmission schemes, offering opportunities to reduce system complexity and associated costs.

In the absence of the presently disclosed approach, alternative designs for self-coherent transceivers may require additional high-speed data converters, active polarization control elements, or emerging optical devices such as meta-surfaces or free-space optical assemblies. Such alternatives can increase design and manufacturing complexity, elevate costs, and introduce uncertainty in performance or reliability. In contrast, the disclosed LO-PI ICR may achieve polarization-insensitive operation without such elements, thereby offering a more practical and robust solution.

In certain embodiments, the disclosed architecture may be applied to microwave or millimeter-wave communication systems in which dual-polarization transmission is employed. In such cases, the underlying principles of polarization-insensitive detection and unitary channel matrix formation remain applicable, allowing similar performance and implementation benefits to be realized in domains beyond optical networking.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

Use of language such as “at least one of X, Y, and Z”, “at least one of X, Y, or Z”, “at least one or more of X, Y, and Z”, “at least one or more of X, Y, and/or Z”, or “at least one of X, Y, and/or Z”, is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

It is contemplated that any part of any aspect or embodiment discussed in this specification can be implemented or combined with any part of any other aspect or embodiment discussed in this specification, so long as such those parts are not mutually exclusive with each other.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

What is claimed is:

1. An apparatus for coherent detection of a dual-polarization optical signal, comprising:
a plurality of optical hybrids configured to receive the dual-polarization optical signal and a local oscillator signal, and to optically mix polarization components thereof to generate a plurality of mixed optical outputs, each representing a combination of polarization components of the dual-polarization optical signal and the local oscillator signal;
a plurality of photodetectors; and
a set of optical routing connections arranged according to a predetermined connection pattern to route the mixed optical outputs to the plurality of photodetectors such that each of the plurality of photodetectors receives a distinct combination of polarization components of the dual-polarization optical signal and the local oscillator signal, wherein the routing of the mixed optical outputs defines a linear transformation between the dual-polarization optical signal and electrical signals generated by the photodetectors, the linear transformation being unitary.

2. The apparatus of claim 1, wherein the plurality of optical hybrids comprises at least two 90-degree optical hybrids.

3. The apparatus of claim 2, wherein the plurality of optical hybrids comprises four 90-degree optical hybrids, each receiving a respective polarization component of the dual-polarization optical signal and a respective polarization component of the local oscillator signal.

4. The apparatus of claim 3, wherein each of the four 90-degree optical hybrids produces four of the mixed optical outputs, and the plurality of photodetectors comprises between four and eight photodetectors, the plurality of photodetectors including at least one of:
(i) four single-ended photodetectors, each connected via a respective one-to-one connection to two of the mixed optical outputs;
(ii) eight photodetectors, each receiving a respective one of the mixed optical outputs; or
(iii) a mixed configuration including single-ended photodetectors and balanced photodetector pairs to provide incremental performance between the four-photodetector and eight-photodetector configurations.

5. The apparatus of claim 4, further comprising:
two polarization beam splitters, each configured to separate polarization components of the dual-polarization optical signal and the local oscillator signal, respectively;
four beam splitters configured to distribute the separated polarization components to the four 90-degree optical hybrids; and
eight polarization beam combiners positioned between the set of optical routing connections and the eight photodetectors, each of the polarization beam combiners configured to combine two of the mixed optical outputs prior to photodetection.

6. The apparatus of claim 5, wherein the set of optical routing connections comprise one-to-one optical waveguide connections between outputs of the four 90-degree optical hybrids and inputs of the eight polarization beam combiners.

7. The apparatus of claim 1, wherein the plurality of photodetectors comprises four balanced photodetector pairs, each configured to subtract photocurrents to generate a differential electrical signal for coherent detection.

8. The apparatus of claim 7, wherein the differential electrical signal is generated from photocurrents corresponding to a respective combination of polarization components of the dual-polarization optical signal and the local oscillator signal.

9. The apparatus of claim 1, further comprising:
a plurality of analog-to-digital converters configured to digitize the electrical signals; and
a digital signal processor configured to process the digitized electrical signals to recover modulation symbols carried by the dual-polarization optical signal.

10. The apparatus of claim 9, wherein the digital signal processor is further configured to jointly equalize the linear transformation defined by the routing and an optical fiber channel response.

11. A method for coherent detection of a dual-polarization optical signal, the method comprising:
receiving the dual-polarization optical signal and a local oscillator signal at a plurality of optical hybrids;
optically mixing, at the plurality of optical hybrids, the dual-polarization optical signal and the local oscillator signal to generate a plurality of mixed optical outputs, each representing a combination of polarization components of the dual-polarization optical signal and the local oscillator signal;
routing the plurality of mixed optical outputs to a plurality of photodetectors through a set of optical routing connections arranged according to a predetermined connection pattern such that each of the plurality of photodetectors receives a distinct combination of polarization components of the dual-polarization optical signal and the local oscillator signal; and
generating electrical signals at the plurality of photodetectors based on the received mixed optical outputs, wherein the routing of the mixed optical outputs defines a linear transformation between the dual-polarization optical signal and the electrical signals, the linear transformation being unitary.

12. The method of claim 11, wherein the plurality of optical hybrids comprises at least two 90-degree optical hybrids.

13. The method of claim 12, wherein the plurality of optical hybrids comprises four 90-degree optical hybrids, each receiving a respective polarization component of the dual-polarization optical signal and a respective polarization component of the local oscillator signal.

14. The method of claim 13, wherein each of the four 90-degree optical hybrids produces four of the mixed optical outputs, and the plurality of photodetectors comprises between four and eight photodetectors, the plurality of photodetectors including at least one of:
(i) four single-ended photodetectors, each connected via a respective one-to-one connection to two of the mixed optical outputs;
(ii) eight photodetectors, each receiving a respective one of the mixed optical outputs; or
(iii) a mixed configuration including single-ended photodetectors and balanced photodetector pairs to provide incremental performance between the four-photodetector and eight-photodetector configurations.

15. The method of claim 14, wherein the dual-polarization optical signal and the local oscillator signal are each passed through two polarization beam splitters to separate the respective polarization components, wherein four beam splitters are used to distribute the separated polarization components to the four 90-degree optical hybrids, and wherein eight polarization beam combiners are positioned between the set of optical routing connections and the eight photodetectors, such that each of the polarization beam combiners combines two of the mixed optical outputs prior to photodetection.

16. The method of claim 15, wherein the set of optical routing connections comprises one-to-one optical waveguide connections between outputs of the four 90-degree optical hybrids and inputs of the eight polarization beam combiners.

17. The method of claim 11, wherein the plurality of photodetectors comprises four balanced photodetector pairs, each configured to subtract photocurrents to generate a differential electrical signal for coherent detection.

18. The method of claim 17, further comprising performing coherent current differentiation to generate the differential electrical signal from photocurrents corresponding to a respective combination of polarization components of the dual-polarization optical signal and the local oscillator signal.

19. The method of claim 11, further comprising:
digitizing the electrical signals using a plurality of analog-to-digital converters; and
processing the digitized electrical signals using a digital signal processor to recover modulation symbols carried by the dual-polarization optical signal.

20. The method of claim 19, wherein the processing comprises jointly equalizing the linear transformation defined by the routing of the mixed optical outputs and an optical fiber channel response.

21. An apparatus for coherent detection of a dual-polarization electromagnetic signal, comprising:
a plurality of hybrids configured to receive the dual-polarization electromagnetic signal and a local oscillator signal, and to mix polarization components thereof to generate a plurality of mixed outputs, each representing a combination of polarization components of the dual-polarization electromagnetic signal and the local oscillator signal;
a plurality of detectors; and
a set of routing connections arranged according to a predetermined connection pattern to route the mixed outputs to the plurality of detectors such that each of the plurality of detectors receives a distinct combination of polarization components of the dual-polarization electromagnetic signal and the local oscillator signal, wherein the routing of the mixed outputs defines a linear transformation between the dual-polarization electromagnetic signal and electrical signals generated by the detectors, the linear transformation being unitary.
